(19) United States
(12) Patent Application Publication
(10) Pub. No.: US 2026/0127905 A1
(43) Pub. Date: May 7, 2026

(54) ARTIFICIAL INTELLIGENCE BASED (AI-BASED) SYSTEMS AND METHODS TO MANAGE ELECTRONIC DOCUMENTS FOR AUTOMATED UNDERWRITING AND PRICING

(71) Applicant: Toorak Capital Partners, Tampa, FL (US)

(72) Inventors: John Beacham, Tampa, FL (US); Sachin Venugopal, Watchung, NJ (US); Chakkrapani Grandhi, Bangalore (IN); Abhishek Jain, Bhind (IN); Daniel Robin K, Mysuru (IN); Mounika Pinnamaneni, Chilakaluripet (IN)

(21) Appl. No.: 18/937,165

(22) Filed: Nov. 5, 2024

(51) Int. Cl. G06V 30/19; G06Q 40/03; G06Q 50/16; G06V 30/148; G06V 30/414; G06V 30/416

(52) U.S. Cl. CPC G06V 30/1916; G06Q 40/03; G06Q 50/167; G06V 30/158; G06V 30/19173; G06V 30/414; G06V 30/416

(57) ABSTRACT

An AI-based system and method for managing electronic documents comprising closing packages, is disclosed. The AI-based method includes receiving the electronic documents comprising closing packages from electronic devices associated with first users; automatically categorizing the electronic documents comprising closing packages, by applying tags on electronic documents, using AI model; splitting each electronic document comprising the closing packages, based on tags, using an AI-based document splitting model; extracting information from types of electronic documents, using the AI model; determining eligibility of loans and base rate settings, upon validation of each electronic document, using AI-based guideline validation model; predicting risk assessment on loans based on market data and internal loan performance metrics, using AI-based risk model; and dynamically adjusting loan pricing and terms in response to market conditions based on combination of eligibility of loans, base rate settings, and risk assessment on the loans, using AI-powered pricing and terms engine.

### FIELD OF INVENTION

Embodiments of the present disclosure relate to artificial intelligence driven (AI-based) systems, and more particularly relates to an AI-based method and system to manage one or more electronic documents including closing packages for providing dynamic risk assessment and loan pricing based on real-time data.

### BACKGROUND

The current process for managing mortgage loans is hindered by substantial challenges in document management and risk assessment. Classifying electronic documents and Handling closing packages, which often exceed a thousand pages, remains an arduous and time-consuming task. These closing packages include a variety of documents, such as notes, appraisals, social security numbers, driver's licenses, loan agreements, and housing and urban development (HUD) documents. Manually sorting these documents may require considerable human effort and time. Document processing in loan closings has always been a bottleneck for users and the document processing may take more than a week to complete because of an amount of paperwork involved in the loan closings.

Additionally, assessing a risk of a loan necessitates accurate and efficient management of diverse data types and sources. The existing methods rely heavily on manual processes and lack the ability to dynamically integrate various data sources that influence loan decisions, leading to inefficiencies and potential inaccuracies in determining loan pricing and terms.

Hence, there is a need for an improved artificial intelligence based (AI-based) system and method for managing one or more electronic documents including closing packages for providing dynamic risk assessment and loan pricing based on real-time data, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence based (AI-based) method for managing one or more electronic documents comprising closing packages, is disclosed. The artificial intelligence based (AI-based) method comprises receiving, by one or more hardware processors, the one or more electronic documents including the closing packages from one or more electronic devices associated with one or more first users. The closing packages comprise a set of the one or more electronic documents associated with one or more financial transactions. The one or more electronic documents are corresponding to a form of a portable document format (PDF).

The AI-based method further comprises automatically categorizing, by the one or more hardware processors, the one or more electronic documents including the closing packages associated with one or more financial transactions, by applying one or more tags on the one or more electronic documents, using an artificial intelligence (AI) model.

The AI-based method further comprises splitting, by the one or more hardware processors, each electronic document of the one or more electronic documents including the closing packages, based on the one or more tags applied on the one or more electronic documents, using an AI-based document splitting model.

The AI-based method further comprises extracting, by the one or more hardware processors, one or more information from one or more types of the one or more electronic documents, using the AI model.

The AI-based method further comprises validating, by the one or more hardware processors, each electronic document of the one or more electronic documents to determine whether each electronic document of the one or more electronic documents are required to a process of one or more loans.

The AI-based method further comprises determining, by the one or more hardware processors, at least one of: eligibility of the one or more loans and base rate settings, upon validation of each electronic document of the one or more electronic documents, using an AI-based guideline validation model.

The AI-based method further comprises predicting, by the one or more hardware processors, risk assessment on the one or more loans for one or more second users based on at least one of: one or more market data and one or more internal loan performance metrics, using an AI-based risk model.

The AI-based method further comprises dynamically adjusting, by the one or more hardware processors, loan pricing and terms in response to market conditions based on a combination of at least one of: the eligibility of the one or more loans, the base rate settings, and the risk assessment on the one or more loans for one or more second users, using an AI-powered pricing and terms engine.

In an embodiment, the AI-based method further comprises training the AI model to automatically categorize the one or more electronic documents. Training the AI model comprises: (a) obtaining, by the one or more hardware processors, one or more first training datasets associated with the one or more text formats of the one or more electronic documents corresponding to one or more predefined tags; (b) generating, by the one or more hardware processors, one or more feature vectors by processing the one or more first training datasets using at least one of: optical character recognition (OCR) engine and natural language processing (NLP) model; (c) correlating, by the one or more hardware processors, the generated one or more feature vectors with one or more respective tags being assigned for the one or more electronic documents; (d) training, by the one or more hardware processors, the AI model based on the correlation between the generated one or more feature vectors and the one or more respective tags, wherein the AI model comprises a Stochastic Gradient Descent (SGD) classification model; and (e) determining, by the one or more hardware processors, one or more tags being applied on the one or more electronic documents to automatically categorize the one or more electronic documents, based on the trained AI model.

In another embodiment, splitting each electronic document of the one or more electronic documents comprising the closing packages, using the AI-based document splitting model, comprises: (a) converting, by the one or more hardware processors, the one or more electronic documents from the portable document format (PDF) to one or more text formats using the OCR engine; (b) processing, by the one or more hardware processors, the converted one or more text formats of the one or more electronic documents to extract a list of page numbers for each electronic document of the one or more electronic documents, using a Spacy named entity recognition (NER) model; (c) converting, by the one or more hardware processors, the one or more electronic documents from the portable document format (PDF) to one or more image formats; (d) predicting, by the one or more hardware processors, a type of one or more pages of the one or more electronic documents based on the converted one or more image formats of the one or more electronic documents, using a convolutional neural network (CNN) model, wherein the type of one or more pages of the one or more electronic documents comprise at least one of: start page, middle page, end page, filler page, and single page, of the one or more electronic documents; (e) determining, by the one or more hardware processors, a boundary of each electronic document of the one or more electronic documents by combining the extracted list of page numbers for each electronic document of the one or more electronic documents and predicted type of the one or more pages of the one or more electronic documents, using the AI-based document splitting model; (f) tagging, by the one or more hardware processors, each electronic documents of the one or more electronic documents based on the one or more types of the one or more electronic documents, using a document tag classifier, wherein the document tag classifier comprises a Stochastic Gradient Descent (SGD) classifier; and (g) splitting, by the one or more hardware processors, each electronic document of the one or more electronic documents based on the one or more tags applied on the one or more electronic documents.

In yet another embodiment, the AI-based method further comprises training the AI model to extract the one or more information from the one or more types of the one or more electronic documents. Training the AI model comprises: (a) obtaining, by the one or more hardware processors, a set of electronic documents comprising the one or more types of the one or more electronic documents, wherein the one or more types of the one or more electronic documents comprise at least one of: one or more notes, housing and urban development document, social security number (SSN), and driving licenses; (b) annotating, by the one or more hardware processors, the one or more types of the one or more electronic documents to indicate one or more key details comprising at least one of: one or more names of the one or more second users, one or more SSN values, and one or more loan values; (c) extracting, by the one or more hardware processors, one or more features from the annotated one or more electronic documents using the NLP model, wherein the NLP model comprises a SpaCy library model; and (d) training, by the one or more hardware processors, the AI model with the extracted one or more features and the annotated one or more electronic documents, to analyze the one or more information from each type of the one or more electronic documents.

In yet another embodiment, the AI-based method further comprises sending, by the one or more hardware processors, one or more notifications to the one or more electronic devices associated with the one or more first users when the one or more electronic documents are at least one of: missing and incomplete. The one or more notifications comprise a request of submission of the one or more electronic documents being missed during the process of the one or more loans.

In yet another embodiment, determining at least one of: eligibility of the one or more loans and the base rate settings using the AI-based guideline validation model, comprises at least one of: (a) determining, by the one or more hardware processors, at least one of: eligibility of the one or more loans and the base rate settings, based on one or more factors comprising at least one of: evaluations of credit score, loan-to-value ratio defining property value corresponding to a loan amount, eligibility of the one or more second users and one or more properties; (b) determining, by the one or more hardware processors, whether the one or more loans meet one or more minimum standards indicating an acceptation of the one or more first users on the one or more loans; (c) determining, by the one or more hardware processors, base pricings for the one or more loans based on one or more first fields comprising at least one of: information associated with a loan amount, experience of the one or more second users, one or more credit scores, and demography; and (d) determining, by the one or more hardware processors, optimized pricings for the one or more loans based on one or more second fields obtained from the one or more second users, wherein the one or more second fields comprise one or more properties belonging to the one or more second users.

In yet another embodiment, the AI-based method further comprises training, by the one or more hardware processors, the AI-based risk model to predict the risk assessment on the one or more loans for the one or more second users. Training the AI-based risk model comprises: (a) obtaining, by the one or more hardware processors, one or more second training datasets comprising one or more data from one or more data sources, wherein the one or more data comprise at least one of: the one or more market data, one or more user geographical and financial data, one or more loan performance data, and one or more social media data; and (b) training, by the one or more hardware processors, the AI-based risk model based on the one or more second training datasets using a grid search approach, wherein the AI-based risk model comprises an extreme gradient boosting (XGBoost) model.

Training the AI-based risk model by: (a) defining, by the one or more hardware processors, a range of values for each hyperparameter to be tuned in the AI-based risk model, wherein defining the range of values for each hyperparameter comprises assigning maximum, minimum, and step size for each hyperparameter of one or more hyperparameters, wherein the one or more hyperparameters comprise at least one of: learning rate, tree depth, and number of trees; (b) generating, by the one or more hardware processors, a grid search space by combining the range of values from the one or more hyperparameters; (c) generating, by the one or more hardware processors, an optimized grid of configurations for the AI-based risk model based on the combination of the range of values from the one or more hyperparameters; and (d) training, by the one or more hardware processors, the XGBoost model on the one or more second trained datasets using k-fold cross-validation to determine robustness and prevent overfitting.

In yet another embodiment, the AI-based method further comprises evaluating, by the one or more hardware processors, performance of the trained AI-based risk model using one or more metrics comprising root mean squared error (RMSE). The RMSE indicates close matching of the prediction of the AI-based risk model with one or more actual values.

In yet another embodiment, the AI-based method further comprises adjusting, by the one or more hardware processors, the one or more hyperparameters to fine-tune the AI-based risk model with minimum RMSE for dynamically predicting the risk assessment with optimized accuracy.

In one aspect, an artificial intelligence based (AI-based) system for managing one or more electronic documents comprising closing packages, is disclosed. The AI-based system includes one or more hardware processors and a memory coupled to the one or more hardware processors. The memory includes a plurality of subsystems in the form of programmable instructions executable by the one or more hardware processors.

The plurality of subsystems comprises a document receiving subsystem configured to receiving, by one or more hardware processors, the one or more electronic documents comprising the closing packages from one or more electronic devices associated with one or more first users. The closing packages comprise a set of the one or more electronic documents associated with one or more financial transactions. The one or more electronic documents are corresponding to a form of a portable document format (PDF).

The plurality of subsystems further comprises a document categorizing subsystem configured to automatically categorize the one or more electronic documents comprising the closing packages associated with financial transactions, by applying one or more tags on the one or more electronic documents, using an artificial intelligence (AI) model.

The plurality of subsystems further comprises a document splitting subsystem configured to split each electronic document of the one or more electronic documents comprising the closing packages, based on the one or more tags applied on the one or more electronic documents, using an AI-based document splitting model.

The plurality of subsystems further comprises an information extraction subsystem configured to extract one or more information from one or more types of the one or more electronic documents, using the AI model.

The plurality of subsystems further comprises a document validation subsystem configured to validate each electronic document of the one or more electronic documents to determine whether each electronic document of the one or more electronic documents are required to a process of one or more loans.

The plurality of subsystems further comprises a loan eligibility determining subsystem configured to determine at least one of: eligibility of the one or more loans and base rate settings, upon validation of each electronic document of the one or more electronic documents, using an AI-based guideline validation model.

The plurality of subsystems further comprises a risk assessment prediction subsystem configured to predict risk assessment on the one or more loans for one or more second users based on at least one of: one or more market data and one or more internal loan performance metrics, using an AI-based risk model.

The plurality of subsystems further comprises a loan price adjusting subsystem configured to dynamically adjust loan pricing and terms in response to market conditions based on a combination of at least one of: the eligibility of the one or more loans, the base rate settings, and the risk assessment on the one or more loans for one or more second users, using an AI-powered pricing and terms engine.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with an artificial intelligence based (AI-based) system for managing one or more electronic documents including closing packages and providing dynamic risk assessment and loan pricing based on real-time data, in accordance with an embodiment of the present disclosure;

FIG. 2 is a detailed view of the artificial intelligence based (AI-based) system for managing the one or more electronic documents including the closing packages and providing the dynamic risk assessment and loan pricing based on the real-time data, in accordance with another embodiment of the present disclosure;

FIG. 3 is an overall process flow of managing the one or more electronic documents including the closing packages and providing the dynamic risk assessment and loan pricing based on the real-time data, in accordance with another embodiment of the present disclosure;

FIG. 4 is a process flow of training an AI model to automatically categorize the one or more electronic documents including the closing packages, in accordance with an embodiment of the present disclosure;

FIG. 5 is a process flow of splitting each electronic document of the one or more electronic documents including the closing packages, using an AI-based document splitting model, in accordance with an embodiment of the present disclosure;

FIG. 6 is a process flow illustrating extraction of a list of page numbers for each electronic document of the one or more electronic documents, in accordance with an embodiment of the present disclosure;

FIG. 7 is a block diagram illustrating prediction of a type of one or more pages of the one or more electronic documents using a convolutional neural network (CNN) model, in accordance with an embodiment of the present disclosure;

FIG. 8 is a process flow illustrating a training process of the AI model for extracting one or more information from one or more types of the one or more electronic documents, in accordance with an embodiment of the present disclosure;

FIG. 9 is a process flow illustrating a prediction process of the trained AI model for extracting the one or more information from the one or more types of the one or more electronic documents, in accordance with an embodiment of the present disclosure;

FIG. 10 is a process flow illustrating a training process of an AI-based risk model for predicting risk assessment on one or more loans for one or more second users, in accordance with an embodiment of the present disclosure;

FIG. 11 is a process flow illustrating a prediction process of the AI-based risk model for predicting risk assessment on the one or more loans for the one or more second users, in accordance with an embodiment of the present disclosure; and

FIG. 12 is a flow chart illustrating an artificial intelligence based (AI-based) method for managing the one or more electronic documents including the closing packages and providing the dynamic risk assessment and loan pricing based on the real-time data, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration. ” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

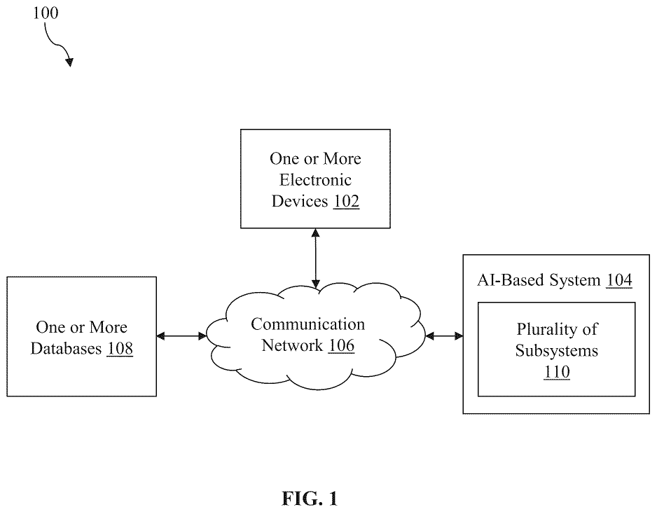

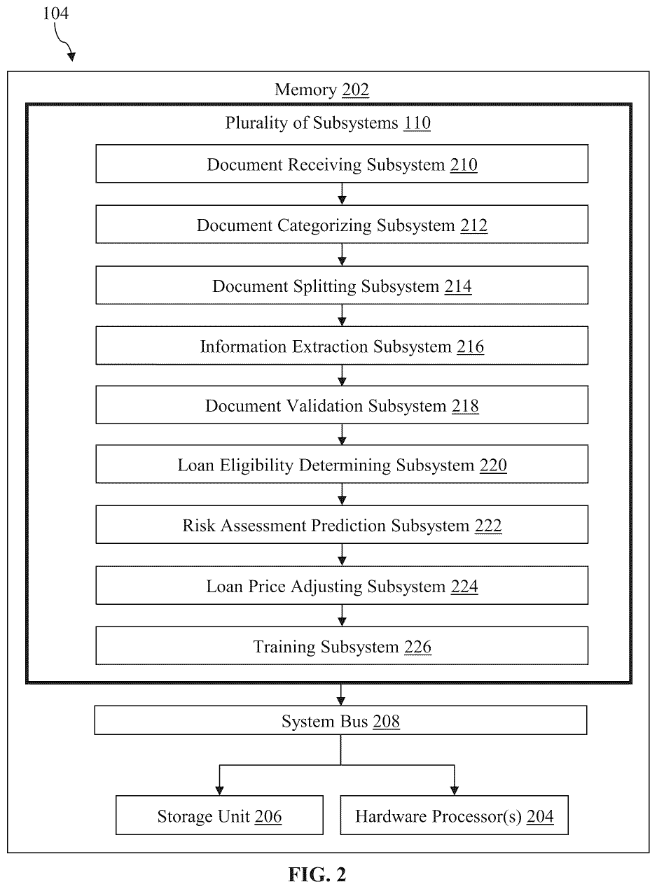

Referring now to the drawings, and more particularly to FIG. 1 through FIG. 12, where similar reference characters denote corresponding features consistently throughout the figures, there are shown preferred embodiments and these embodiments are described in the context of the following exemplary system and/or method.

FIG. 1 is a block diagram illustrating a computing environment 100 with an artificial intelligence based (AI-based) system 104 for managing one or more electronic documents including closing packages (may be one or more closing packages) and providing dynamic risk assessment and loan pricing based on real-time data, in accordance with an embodiment of the present disclosure. According to FIG. 1, the computing environment 100 includes one or more electronic devices 102 that are communicatively coupled to the AI-based system 104 through a communication network 106. The one or more electronic devices 102 through which one or more first users provide one or more inputs to the AI-based system 104.

In an embodiment, the one or more first users may include at least one of: one or more data analysts, one or more business analysts, one or more cash analysts, one or more financial analysts, one or more collection analysts, one or more debt collectors, one or more professionals associated with cash and collection management, and the like.

The present invention is configured to manage the one or more electronic documents including the closing packages and predict the risk assessment on the one or more loans for one or more second users. The AI-based system 104 is initially configured to receive the one or more electronic documents including the closing packages from one or more electronic devices 102 associated with the one or more first users. In an embodiment, the closing packages may include a set of the one or more electronic documents associated with one or more financial transactions. In an embodiment, the one or more electronic documents are corresponding to a form of a portable document format (PDF).

The AI-based system 104 is further configured to automatically categorize the one or more electronic documents including the closing packages associated with one or more financial transactions, by applying one or more tags on the one or more electronic documents, using an artificial intelligence (AI) model. The AI-based system 104 is further configured to split each electronic document of the one or more electronic documents including the closing packages, based on the one or more tags applied on the one or more electronic documents, using the AI-based document splitting model.

The AI-based system 104 is further configured to extract one or more information from one or more types of the one or more electronic documents, using the AI model. The AI-based system 104 is further configured to validate each electronic document of the one or more electronic documents to determine whether each electronic document of the one or more electronic documents are required to a process of one or more loans. The AI-based system 104 is further configured to determine at least one of: eligibility of the one or more loans and base rate settings, upon validation of each electronic document of the one or more electronic documents, using an AI-based guideline validation model.

The AI-based system 104 is further configured to predict the risk assessment on the one or more loans for the one or more second users based on at least one of: one or more market data and one or more internal loan performance metrics, using an AI-based risk model. In an embodiment, the one or more second users may include at least one of: one or more debtors, one or more customers, one or more organizations, an individual within the one or more organizations, one or more parent companies, one or more subsidiaries, one or more joint ventures, one or more partnerships, one or more legal entities, and the like.

The AI-based system 104 may be hosted on a central server including at least one of: a cloud server or a remote server. Further, the communication network 106 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more electronic devices 102 may include at least one of: a laptop computer, a desktop computer, a tablet computer, a Smartphone, a wearable device, a Smart watch, and the like.

Further, the computing environment 100 includes one or more databases 108 communicatively coupled to the AI-based system 104 through the communication network 106. In an embodiment, the one or more databases 108 includes at least one of: one or more relational databases, one or more object-oriented databases, one or more data warehouses, one or more cloud-based databases, and the like. In another embodiment, a format of the one or more data generated from the one or more databases 108 may include at least one of: a comma-separated values (CSV) format, a JavaScript Object Notation (JSON) format, an Extensible Markup Language (XML), spreadsheets, and the like. Furthermore, the one or more electronic devices 102 include at least one of: a local browser, a mobile application, and the like.

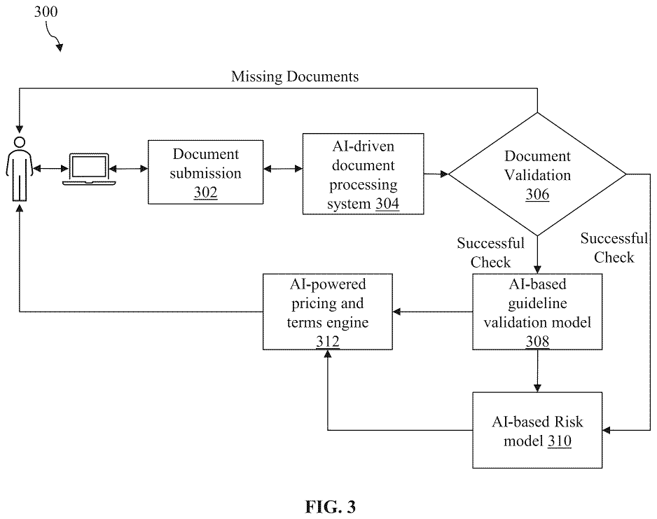

Furthermore, the one or more first users may use a web application through the local browser, the mobile application to communicate with the AI-based system 104. In an embodiment of the present disclosure, the AI-based system 104 includes a plurality of subsystems 110. Details on the plurality of subsystems 110 have been elaborated in subsequent paragraphs of the present description with reference to FIG. 2.

FIG. 2 is a detailed view of the artificial intelligence based (AI-based) method for managing the one or more electronic documents including the closing packages and providing the dynamic risk assessment and loan pricing based on the real-time data, in accordance with another embodiment of the present disclosure. The AI-based system 104 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes a document receiving subsystem 210, a document categorizing subsystem 212, a document splitting subsystem 214, an information extraction subsystem 216, a document validation subsystem 218, a loan eligibility determining subsystem 220, a risk assessment prediction subsystem 222, a loan price adjusting subsystem 224, and a training subsystem 226.

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 110.

The plurality of subsystems 110 includes the document receiving subsystem 210 that is communicatively connected to the one or more hardware processors 204. The document receiving subsystem 210 is configured to receive electronic documents including the closing packages from the one or more electronic devices 102 associated with the one or more first users. The closing packages may include the set of the one or more electronic documents associated with the one or more financial transactions. In an embodiment, the one or more electronic documents are corresponding to a form of the portable document format (PDF). In an embodiment, the one or more first users may include at least one of: the one or more data analysts, the one or more business analysts, the one or more cash analysts, the one or more financial analysts, the one or more collection analysts, the one or more debt collectors, and the one or more professionals associated with the cash and collection management.

The plurality of subsystems 110 further includes the document categorizing subsystem 212 that is communicatively connected to the one or more hardware processors 204. The document categorizing subsystem 212 is configured to automatically categorize the one or more electronic documents including the closing packages associated with the one or more financial transactions, by applying the one or more tags on the one or more electronic documents, using the artificial intelligence (AI) model. For automatically categorize the one or more electronic documents including the closing packages, the document categorizing subsystem 212 is configured to convert the PDF documents from the closing packages into one or more text formats using an optical recognition engine (e.g., a tesseract optical recognition (OCR) engine). The conversion may facilitate further text-based processing and analysis.

The plurality of subsystems 110 further includes the training subsystem 226 that is communicatively connected to the one or more hardware processors 204. The training subsystem 226 is configured to train the AI model for automatically categorizing the one or more electronic documents including the closing packages. For training the AI model, the training subsystem 226 is configured to obtain one or more first training datasets associated with the one or more text formats of the one or more electronic documents corresponding to one or more predefined tags. The training subsystem 226 is further configured to generate one or more feature vectors (e.g., X=[X₁, X₂,. X_{d}]) by processing the one or more first training datasets using at least one of: the optical character recognition (OCR) engine and a natural language processing (NLP) model. The training subsystem 226 is further configured to correlate the generated one or more feature vectors with one or more respective tags being assigned for the one or more electronic documents.

The training subsystem 226 is further configured to train the AI model based on the correlation between the generated one or more feature vectors and the one or more respective tags. In an embodiment, the AI model may include a Stochastic Gradient Descent (SGD) classification model. In other words, the correlation of the generated one or more feature vectors and the one or more respective tags, is inputted to the Stochastic Gradient Descent (SGD) classification model to develop a predictive AI model.

The document categorizing subsystem 212 is further configured to determine one or more tags being applied on the one or more electronic documents to automatically categorize the one or more electronic documents, based on the trained AI model.

The plurality of subsystems 110 further includes the document splitting subsystem 214 that is communicatively connected to the one or more hardware processors 204. The document splitting subsystem 214 may have an AI-powered document segregation system configured to automate the separation and categorization of the one or more electronic documents including the large loan closing packages. The document splitting process may be initiated when a document tagging process detects closing package tag within a group of electronic documents. The document splitting subsystem 214 may integrate the optical character recognition (OCR) and natural language processing (NLP) to enhance the efficiency and accuracy of document segregation. The document splitting subsystem 214 is configured to split each electronic document of the one or more electronic documents including the closing packages, based on the one or more tags applied on the one or more electronic documents, using the AI-based document splitting model.

For splitting each electronic document of the one or more electronic documents including the closing packages, using the AI-based document splitting model, the document splitting subsystem 214 is configured to convert the one or more electronic documents from the portable document format (PDF) to the one or more text formats using the OCR engine (e.g., the Tesseract OCR engine). The document splitting subsystem 214 is further configured to process the converted one or more text formats of the one or more electronic documents to extract a list of page numbers for each electronic document of the one or more electronic documents, using a Spacy named entity recognition (NER) model. In an embodiment, the document splitting subsystem 214 is configured to mark the page number “none” if the page does not have any number. In an embodiment, the comprehensive list of page numbers is compiled for subsequent processes.

The document splitting subsystem 214 is further configured to convert the one or more electronic documents from the portable document format (PDF) to one or more image formats. The document splitting subsystem 214 is further configured to predict a type of one or more pages of the one or more electronic documents based on the converted one or more image formats of the one or more electronic documents, using a convolutional neural network (CNN) model. In an embodiment, the type of one or more pages of the one or more electronic documents may include at least one of: start page (F), middle page (M), end page (L), filler page (F), and single page(S), of the one or more electronic documents. In an embodiment, advanced pattern recognition capabilities of the CNN model are critical for accurate page type determination.

The document splitting subsystem 214 is further configured to determine a boundary of each electronic document of the one or more electronic documents by combining the extracted list of page numbers for each electronic document of the one or more electronic documents and predicted type of the one or more pages of the one or more electronic documents, using the AI-based document splitting model. The document splitting subsystem 214 is further configured to tag each electronic documents of the one or more electronic documents based on the one or more types of the one or more electronic documents, using a document tag classifier. In an embodiment, the document tag classifier may include a Stochastic Gradient Descent Classifier (SGDClassifier).

In other words, first two pages of the electronic documents and the single page electronic document, are processed through a SGDClassifier which tags the one or more electronic documents based on the one or more types of the one or more electronic documents. The document splitting subsystem 214 is further configured to split each electronic document of the one or more electronic documents based on the one or more tags applied on the one or more electronic documents. In an embodiment, the document splitting is further refined based on the tags identified within the group of the one or more electronic documents, ensuring accurate separation and categorization of the one or more electronic documents. In an embodiment, each classified electronic document may be stored in a designated directory with its corresponding tag name, simplifying access for loan processors.

The plurality of subsystems 110 further includes the information extraction subsystem 216 that is communicatively connected to the one or more hardware processors 204. The information extraction subsystem 216 is configured to extract the one or more information from the one or more types of the one or more electronic documents, using the AI model. The training subsystem 226 is configured to train the AI model for extracting the one or more information from the one or more types of the one or more electronic documents.

The training subsystem 226 is configured to obtain a set of electronic documents including the one or more types of the one or more electronic documents. In an embodiment, the one or more types of the one or more electronic documents may include at least one of: one or more notes, housing and urban development document, social security number (SSN), driving licenses, and the like. The training subsystem 226 is further configured to annotate the one or more types of the one or more electronic documents to indicate one or more key details including at least one of: one or more names of the one or more second users, one or more SSN values, one or more loan values, and the like.

The training subsystem 226 is further configured to extract one or more features from the annotated one or more electronic documents using the NLP model. In an embodiment, the NLP model may include a SpaCy library model. The training subsystem 226 is further configured to train AI model with the extracted one or more features and the annotated one or more electronic documents, to analyze the one or more information from each type of the one or more electronic documents.

During a prediction phase of the document extraction, the information extraction subsystem 216 is configured to obtain a new electronic document. The information extraction subsystem 216 is further configured to apply necessary pre-processing steps including at least one of: text cleaning, OCR (if the document is in image format), and feature extraction. The information extraction subsystem 216 is further configured to utilize the trained AI model to identify and extract the required details (e.g., the one or more names of the one or more second users, the one or more SSN values, the one or more loan values, and the like.) from the electronic document. The information extraction subsystem 216 is further configured to execute the extracted details into a structured format for further use or analysis.

The plurality of subsystems 110 further includes the document validation subsystem 218 that is communicatively connected to the one or more hardware processors 204. The document validation subsystem 218 is configured to validate each electronic document of the one or more electronic documents to determine whether each electronic document of the one or more electronic documents are required to the process of one or more loans. In an embodiment, the document validation subsystem 218 is configured to perform a thorough review to check for the presence and accuracy of the one or more electronic documents.

In an embodiment, the document validation subsystem is further configured to send one or more notifications to the one or more electronic devices 102 associated with the one or more first users when the one or more electronic documents are missing or incomplete. In an embodiment, the one or more notifications may include a request of submission of the one or more electronic documents being missed during the process of the one or more loans. In an embodiment, the document validation subsystem is further configured to ensure that the one or more electronic documents are aligned with the requirements of the specific loan type being processed.

The plurality of subsystems 110 further includes the loan eligibility determining subsystem 220 that is communicatively connected to the one or more hardware processors 204. The loan eligibility determining subsystem 220 is configured to determine at least one of: the eligibility of the one or more loans and the base rate settings, upon validation of each electronic document of the one or more electronic documents, using the AI-based guideline validation model. The AI-based guideline validation model is a static model utilizing a set of business-defined criteria to determine loan eligibility and the base rate settings.

The process of determination of loan eligibility and the base rate settings, involves three different checks including at least one of: critical checks, mandatory checks, and secondary checks.

The critical checks are fundamental checks that determine whether a loan application can proceed or not. The one or more loans may be rejected when the one or more loans fail at least one of: the critical checks, the mandatory checks, and the secondary checks. In an embodiment, the loan eligibility determining subsystem 220 is configured to determine at least one of: the eligibility of the one or more loans and the base rate settings, based on one or more factors including at least one of: evaluations of credit score, loan-to-value ratio defining property value corresponding to a loan amount, eligibility of the one or more second users and one or more properties. The loan eligibility determining subsystem 220 is further configured to determine whether the one or more loans meet one or more minimum standards indicating an acceptation of the one or more first users on the one or more loans.

The mandatory checks are also crucial but focus on setting the terms of the one or more loans rather than determining outright eligibility. If the one or more loan passes the mandatory checks, then the loan eligibility determining subsystem 220 is configured to move forward with what's known as base pricing. The loan eligibility determining subsystem 220 is configured to determine base pricings for the one or more loans based on one or more first fields including at least one of: information associated with a loan amount, experience of the one or more second users, one or more credit scores (e.g., FICO® Score), demography, and the like.

The secondary checks are based on user's ability to provide optional fields which may help calculating a better pricing. In other words, the loan eligibility determining subsystem 220 is configured to determine optimized pricings for the one or more loans based on one or more second fields obtained from the one or more second users. In an embodiment, the one or more second fields may include one or more properties belonging to the one or more second users.

The plurality of subsystems 110 further includes the risk assessment prediction subsystem 222 that is communicatively connected to the one or more hardware processors 204. The risk assessment prediction subsystem 222 is configured to predict the risk assessment on the one or more loans for one or more second users based on at least one of: one or more market data and one or more internal loan performance metrics, using the AI-based risk model. In an embodiment, the risk assessment prediction subsystem 222 is configured to incorporate Toorak's loan performance data from previous years, market data in terms of location, loan delinquency data, user geographical data and financial data and social media data. The risk assessment prediction subsystem 222 is configured to utilize the AI-based risk model to establish risk criteria and scaling, for enhancing the precision of the risk assessment.

For predicting the risk assessment on the one or more loans for one or more second users, the training subsystem 226 is initially configured to obtain one or more second training datasets including one or more data from one or more data sources. In an embodiment, the one or more data may include at least one of: the one or more market data, one or more user geographical and financial data, one or more loan performance data, one or more social media data, and the like. The training subsystem 226 is further configured to train the AI-based risk model based on the one or more second training datasets using a grid search approach. In an embodiment, the AI-based risk model may include an extreme gradient boosting (XGBoost) model.

The training subsystem 226 is further configured to define a range of values for each hyperparameter to be tuned in the AI-based risk model. In an embodiment, defining the range of values for each hyperparameter may include at least one of: assigning maximum, minimum, and step size for each hyperparameter of one or more hyperparameters. In an embodiment, the one or more hyperparameters comprise at least one of: learning rate, tree depth, number of trees, and the like. The training subsystem 226 is further configured to generate a grid search space by combining the range of values from the one or more hyperparameters, which creates vast grid of potential model configurations.

The training subsystem 226 is further configured to generate an optimized grid of configurations for the AI-based risk model (e.g., the XGBoost model) based on the combination of the range of values from the one or more hyperparameters. The training subsystem 226 is further configured to train the XGBoost model on the one or more second trained datasets using k-fold cross-validation to determine robustness and prevent overfitting.

The training subsystem 226 is further configured to evaluate performance of the trained AI-based risk model using one or more metrics including root mean squared error (RMSE). In an embodiment, the RMSE indicates close matching of the prediction of the AI-based risk model with one or more actual values. In an embodiment, the trained AI-based risk model with the lowest RMSE is considered the best performing configuration. The training process iterates through the grid search space, refining the parameter values and searching for the optimal set of parameters that minimizes the RMSE. In other word, the training subsystem 226 is further configured to adjust the one or more hyperparameters to fine-tune the AI-based risk model with minimum RMSE for dynamically predicting the risk assessment with optimized accuracy.

In an embodiment, the training subsystem 226 is further configured to determine whether the AI-based risk model is accurate enough. If the AI-based risk model does not meet an accuracy threshold then the training process returns to redefining the range of searching near the optimal hyper parameters, and reduces the search step. The iterative refinement of the search space may help to pinpoint the most effective combination of the one r more hyperparameters for the AI-based risk model.

During the prediction phase of the risk assessment prediction, the risk assessment prediction subsystem 222 is configured to utilize the AI-based risk model representing the underlying knowledge about credit risk factors including at least one of: collection of rules, a machine learning model, or a combination of both. The risk assessment prediction subsystem 222 is configured to obtain the data that are used to make predictions. The data may include at least one of: information on loan applicants, past borrower behavior, economic indicators, and the like. The risk assessment prediction subsystem 222 is configured to use XGBoost optimal hyperparameter value representing optimal settings for the XGBoost model. The optimal settings are determined through a process of tuning the model's hyperparameters. In an embodiment, the XGBoost model is trained with the optimal hyperparameters. The trained XGBoost model is configured to make predictions about the creditworthiness of the one or more second users or businesses based on the current data.

The plurality of subsystems 110 further includes the loan price adjusting subsystem 224 that is communicatively connected to the one or more hardware processors 204. The loan price adjusting subsystem 224 is configured to dynamically adjust the loan pricing and terms in response to the market conditions based on the combination of at least one of: the eligibility of the one or more loans, the base rate settings, and the risk assessment on the one or more loans for one or more second users, using the AI-powered pricing and terms engine. In an embodiment, the AI-powered pricing and terms engine is adaptable and configured to respond to changes in the market conditions, offering favourable terms based on the broader economic environment and individual borrower profiles. For example, if a housing market is doing well and risk is on a personal borrower, the AI-powered pricing and terms engine may provide a good price range. However, if there are changes in the market conditions (i.e., the market is not doing too well), the AI-powered pricing and terms engine may provide good price range for a borrower having lots of experience, to mitigate the risk.

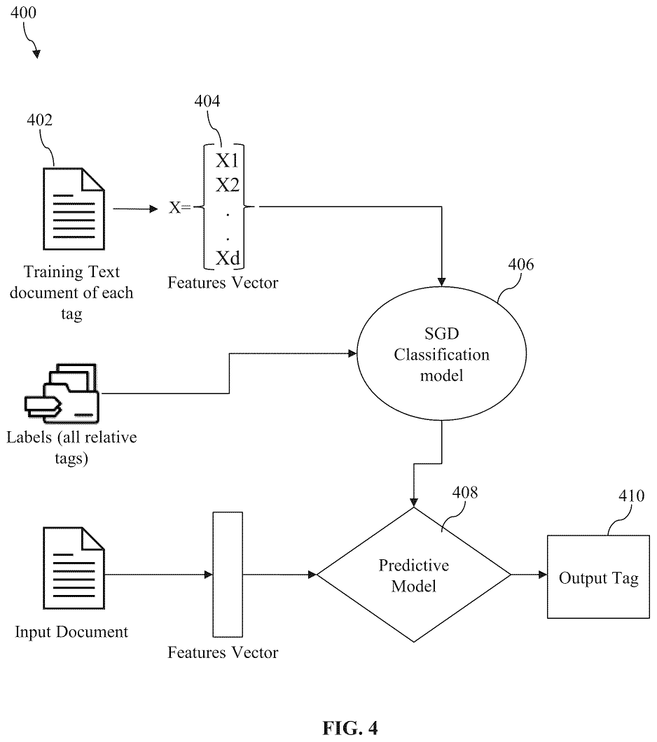

FIG. 3 is an overall process flow 300 of managing the one or more electronic documents including the closing packages and providing the dynamic risk assessment and loan pricing based on the real-time data, in accordance with another embodiment of the present disclosure. The one or more electronic documents including closing packages including the one or more electronic documents are submitted at the AI-based system 104 from the one or more electronic devices 102 associated with the one or more first users, as shown in step 302. The AI-based system 104 (i.e., AI-driven document processing system) is configured to process the one or more electronic documents, wherein processing of the one or more electronic documents include automatic categorization, splitting, of the one or more electronic documents, and extracting of the one or more information from the one or more electronic documents, as shown in step 304.

At step 306, each electronic document of the one or more electronic documents is validated to determine whether each electronic document of the one or more electronic documents are required to the process of one or more loans. At step 308, the AI-based guideline validation model is configured to determine at least one of: the eligibility of the one or more loans and the base rate settings, upon validation of each electronic document of the one or more electronic documents. At step 310, the AI-based risk model is configured to predict the risk assessment on the one or more loans for one or more second users based on at least one of: the one or more market data and the one or more internal loan performance metrics.

At step 312, the AI-powered pricing and terms engine is configured to dynamically adjust the loan pricing and terms in response to the market conditions based on the combination of at least one of: the eligibility of the one or more loans, the base rate settings, and the risk assessment on the one or more loans for one or more second users.

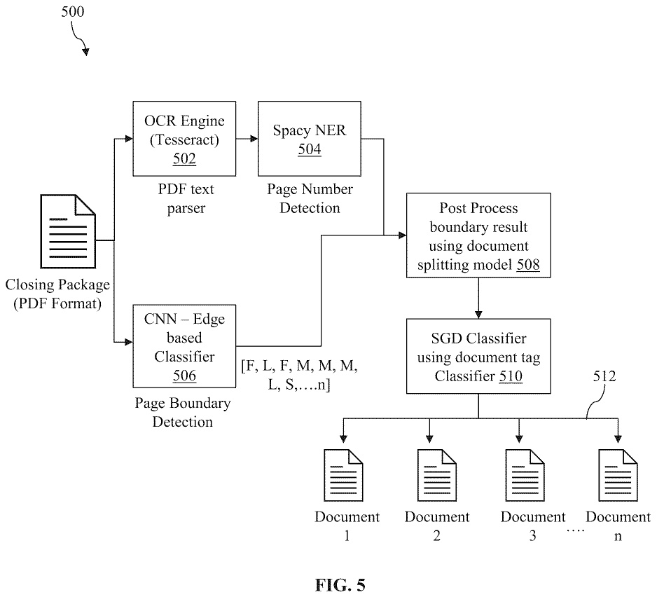

FIG. 4 is a process flow 400 of training the AI model to automatically categorize the one or more electronic documents including the closing packages, in accordance with an embodiment of the present disclosure. At step 402, the one or more first training datasets associated with the one or more text formats of the one or more electronic documents corresponding to one or more predefined tags, are obtained. At step 404, the one or more feature vectors are generated by processing the one or more first training datasets using at least one of: the optical character recognition (OCR) engine and the natural language processing (NLP) model.

At step 406, the generated one or more feature vectors are correlated with the one or more respective tags being assigned for the one or more electronic documents. The AI model is trained to generate the predictive model, as shown in step 408, based on the correlation between the generated one or more feature vectors and the one or more respective tags. In an embodiment, the AI model may include the Stochastic Gradient Descent (SGD) classification model. At step 410, the one or more tags being applied on the one or more electronic documents are determined to automatically categorize the one or more electronic documents, based on the trained AI model, upon inputting an electronic document with the one or more feature vectors.

In other words, the process flow 400 initiates with raw text documents as input, as shown in step 402. Transitioning to feature vectors, as shown in step 404, the textual input is transformed into a numerical representation. This step involves extracting important characteristics (i.e., one or more features) from the text, including at least one of: word frequencies, presence of specific terms, and other linguistic patterns. As a next step, one or more labels are defined for each document, including at least one of: Note, SSN, Passport, HUDD etc. The core of the system lies within the SGD classification model, as shown in step 406, leveraging the power of Stochastic Gradient Descent (SGD) to map feature vectors to the correct labels. Through iterative adjustments of internal parameters, the SGD classification model minimizes errors in prediction. During testing, this custom-trained model is utilized to predict documents. The type of features used during training may be retained to enable the conversion of text documents into feature vectors for accurate label prediction.

FIG. 5 is a process flow 500 of splitting each electronic document of the one or more electronic documents including the closing packages, using an AI-based document splitting model, in accordance with an embodiment of the present disclosure. At step 502, the one or more electronic documents are converted from the portable document format (PDF) to the one or more text formats using the OCR engine (e.g., the Tesseract OCR engine). At step 504, the converted one or more text formats of the one or more electronic documents are converted to extract the list of page numbers for each electronic document of the one or more electronic documents, using the Spacy named entity recognition (NER) model.

At step 506, the type of the one or more pages of the one or more electronic documents are predicted based on the converted one or more image formats of the one or more electronic documents, using the convolutional neural network (CNN) model. In an embodiment, the type of one or more pages of the one or more electronic documents may include at least one of: start page (F), middle page (M), end page (L), filler page (F), and single page(S), of the one or more electronic documents. At step 508, the boundary of each electronic document of the one or more electronic documents is determined by combining the extracted list of page numbers for each electronic document of the one or more electronic documents and predicted type of the one or more pages of the one or more electronic documents, using the AI-based document splitting model.

At step 510, each electronic documents of the one or more electronic documents is tagged based on the one or more types of the one or more electronic documents, using the document tag classifier (e.g., the Stochastic Gradient Descent (SGD) classifier). At step 512, each electronic document of the one or more electronic documents is split based on the one or more tags applied on the one or more electronic documents.

In other words, the process flow 500 initiates with the Tesseract OCR engine, as shown in step 502, which undertakes a crucial task of converting the PDF documents into text formats. Subsequent to this conversion, the Spacy NER model, as shown in step 504, adeptly extracts essential page numbers from each page within the electronic document. Simultaneously, the Convolutional Neural Network (CNN) model, as shown in step 506, operates in parallel, discerning the type of page from the PDF document with remarkable accuracy. These parallel processes yield lists of page results, which are seamlessly transmitted to the Document Splitter Model, as shown in step 508. Here, meticulous processing of the lists and results occurs, ultimately yielding a final list delineating individual document boundaries extracted from the larger closing document. The delineated boundaries are then transmitted to the SGDClassifier, as shown in 510, which undertakes the task of predicting the tag of each identified electronic document. Upon completion of this prediction process, the AI-based system 104 efficiently saves each electronic document with its specific tag as a filename in a predefined directory.

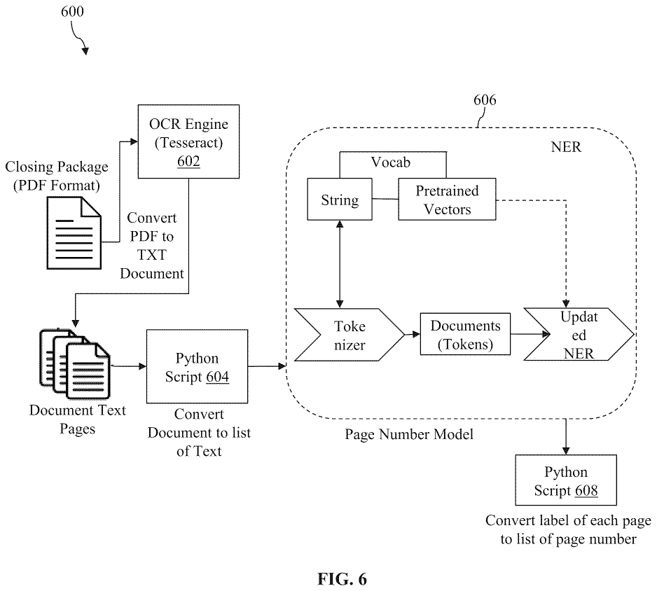

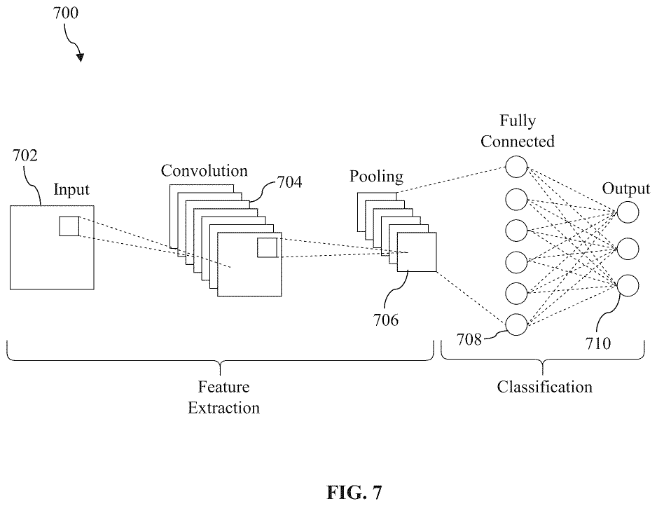

FIG. 6 is a process flow 600 illustrating extraction of the list of page numbers for each electronic document of the one or more electronic documents, in accordance with an embodiment of the present disclosure. At step 602, the one or more electronic documents are converted from the portable document format (PDF) to the one or more text formats using the OCR engine. At step 604, the one or more electronic documents are converted to list of texts, using python script. At step 606, the converted one or more text formats of the one or more electronic documents are processed to extract the list of page numbers for each electronic document of the one or more electronic documents, using the Spacy named entity recognition (NER) model. At step 608, the label of each page of the one or more electronic documents to the list of page numbers corresponding to each electronic document of the one or more electronic documents, using the python script.

In other words, the process flow 600 begins with the PDF document as input, which undergoes conversion into a text document using Tesseract 602. Subsequently, the Python script 604 processes this text document into a list of text pages. The next step involves the page number model 605, where the text undergoes tokenization using language-specific rules. Each token is processed by a Tokenizer, which accesses a vocabulary (Vocab) table to check for various features including ta least one of: prefix, suffix, shape, and normalized form (lowercase form). If any feature is absent, it is added to the vocabulary. The output of the Tokenizer is a Doc object, representing a sequence of tokens. An updated NER model is configured to operate on the document object, returning page number entities within the input text along with their respective probability scores. Finally, a post-processing Python script 608 aggregates the extracted page numbers for each page, presenting them as a list of page number entities.

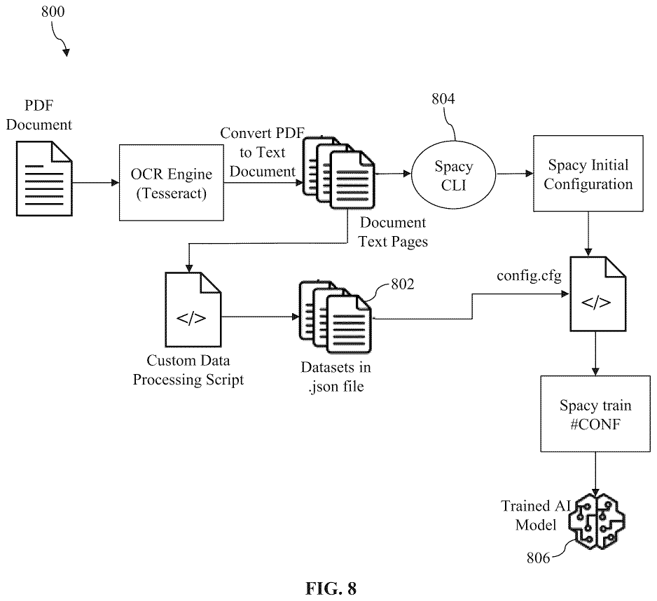

FIG. 7 is a block diagram 700 illustrating prediction of a type of one or more pages of the one or more electronic documents using a convolutional neural network (CNN) model, in accordance with an embodiment of the present disclosure. Beginning with an image as input 702, the process advances through feature extraction involving convolution 704 and pooling 706. During convolution 704, the CNN extracts significant features from the input 702 using a series of filters, or kernels, which slide across the image, performing calculations at each step. These filters are adept at detecting patterns like edges, shapes, and textures. Subsequently, in the pooling stage 706, the output 710 of the convolutional layers is downsized. This step aids in reducing computation, enhancing the network's robustness to slight input variations, and focusing on the most critical features. A prevalent type of pooling is max-pooling, which selects the maximum value within a small window. Following feature extraction, the process moves to classification, where a fully connected layer 708 analyzes the features and learns to make predictions. Finally, at the output stage 710, the CNN predicts the probability of each label (e.g., startPage, endPage, middlePage, singlePage, or fillerPage), for the given input 702 and outputs 710 the label with the highest probability using an argmax operation.

FIG. 8 is a process flow illustrating a training process of the AI model for extracting one or more information from one or more types of the one or more electronic documents, in accordance with an embodiment of the present disclosure. At step 802, the set of electronic documents including the one or more types of the one or more electronic documents, is obtained. In an embodiment, the one or more types of the one or more electronic documents may include at least one of: the one or more notes, the housing and urban development document, the social security number (SSN), the driving licenses, and the like. At step 804, the one or more types of the one or more electronic documents are annotated to indicate the one or more key details including at least one of: the one or more names of the one or more second users, the one or more SSN values, the one or more loan values, and the like.

The one or more features are extracted from the annotated one or more electronic documents using the NLP model. The NLP model may include a SpaCy library model. At step 806, the AI model is trained with the extracted one or more features and the annotated one or more electronic documents, to analyze the one or more information from each type of the one or more electronic documents.

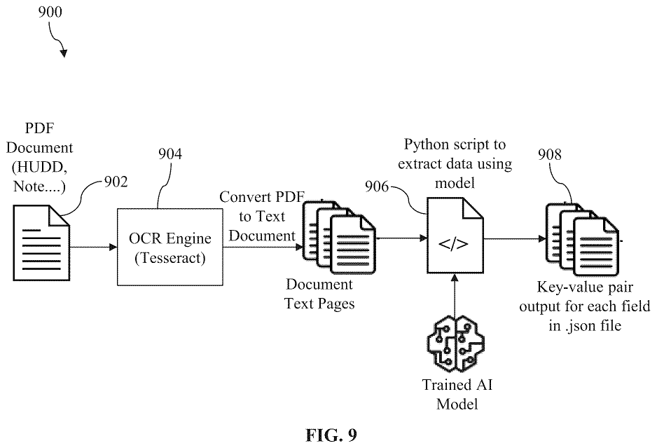

FIG. 9 is a process flow 900 illustrating a prediction process of the trained AI model for extracting the one or more information from the one or more types of the one or more electronic documents, in accordance with an embodiment of the present disclosure. At step 902, a new electronic document is inputted to the AI-based system 104. At step 904, one or more pre-processing steps including at least one of: cleaning the electronic documents, converting the format of the electronic documents (e.g., if the electronic document is in image format), extracting the features of the electronic documents, and the like. At step 906, the trained AI model is utilized to identify and extract the required information including at least one of: one or more names of the one or more second users, one or more SSN values, one or more loan values, and the like, from the one or more electronic documents. At step 908, the extracted information is executed into a structured format for further use or analysis.

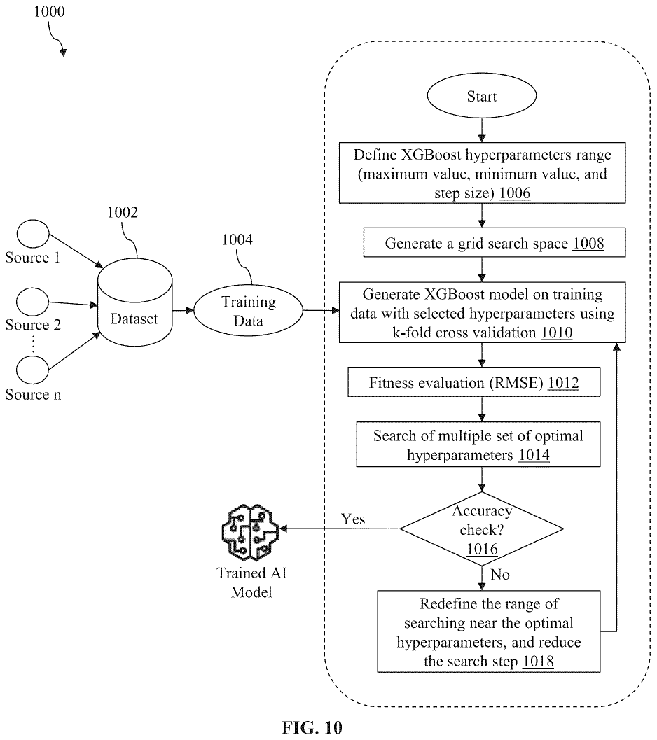

FIG. 10 is a process flow 1000 illustrating a training process of the AI-based risk model for predicting the risk assessment on the one or more loans for the one or more second users, in accordance with an embodiment of the present disclosure. At step 1002, the one or more second training datasets including the one or more data, are obtained from the one or more data sources. In an embodiment, the one or more data may include at least one of: the one or more market data, the one or more user geographical and financial data, the one or more loan performance data, the one or more social media data, and the like.

At step 1004, the one or more second training datasets are inputted to the trained AI-based risk model. At step 1006, the range of values for each hyperparameter (i.e., XGBoost hyperparameters) is defined to be tuned in the AI-based risk model. In an embodiment, defining the range of values for each hyperparameter may include at least one of: assigning maximum, minimum, and step size for each hyperparameter of the one or more hyperparameters. At step 1008, the grid search space are generated by combining the range of values from the one or more hyperparameters.

At step 1010, the XGBoost model is trained in the one or more second training datasets using k-fold cross-validation to determine robustness and prevent overfitting. At step 1012, the performance of the trained AI-based risk model is evaluated using the one or more metrics comprising root mean squared error (RMSE). In an embodiment, the RMSE indicates close matching of the prediction of the AI-based risk model with the one or more actual values. At step 1014, the AI-based risk model with the lowest is considered the best performing configuration. In an embodiment, the process iterates through the grid search space, refining the parameter values and searching for the optimal set of parameters that minimizes the RMSE. At step 1016, the AI-based system 104 check the accuracy of the AI-based risk model. If the accuracy of the AI-based risk model meets the accuracy threshold, the AI-based risk model is trained with the parameter values having the lowest RMSE value. If the accuracy of the AI-based risk model does not meet the accuracy threshold, then the AI-based system 104 is configured to refine the range of searching near the optimal hyperparameters, and reduces the search step. In other words, the AI-based system 104 is configured to adjust the one or more hyperparameters to fine-tune the AI-based risk model with minimum RMSE for dynamically predicting the risk assessment with optimized accuracy. The iterative refinement of the search space helps to pinpoint the most effective combination of the one or more hyperparameters for the AI-based risk model.

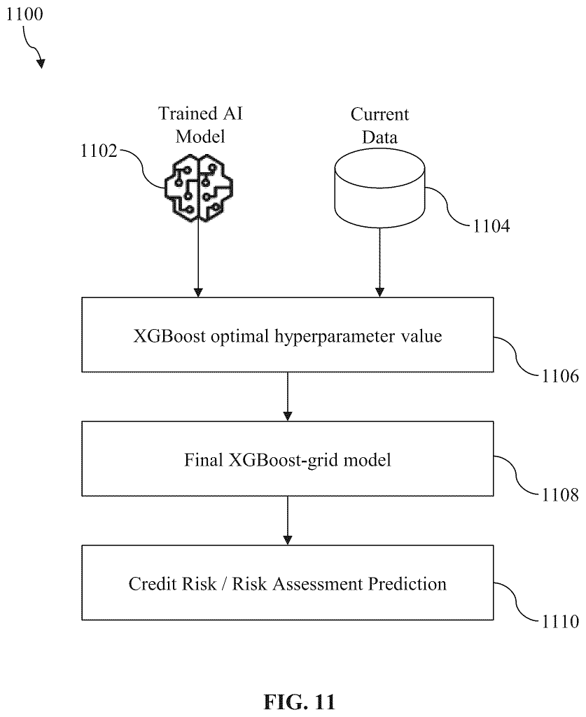

FIG. 11 is a process flow illustrating a prediction process of the AI-based risk model for predicting risk assessment on the one or more loans for the one or more second users, in accordance with an embodiment of the present disclosure. The AI-based risk model, as shown in 1102, may represent underlying knowledge about one or more credit risk factors. The AI-based risk model may be a collection of rules, a machine learning model, or a combination of both. The one or more current data, as shown in 1104, may refer to the data that are used to make predictions. Th one or more current data may include information on loan applicants, past borrower behavior, economic indicators, and the like.

The XGBoost optimal hyperparameter value, as shown in 1106, may represent one or more optimal settings for the XGBoost model. The one or more optimal settings are determined through a process of tuning the model's hyperparameters. The final XGBoost-grid model, as shown in 1108, is the XGBoost model trained with the optimal hyperparameters found in the previous step 1106. The credit risk prediction, as shown in 1110, is an output of the AI-based system 104. The XGBoost model makes predictions about the creditworthiness of individuals (e.g., the one or more second users) or businesses based on the one or more current data.

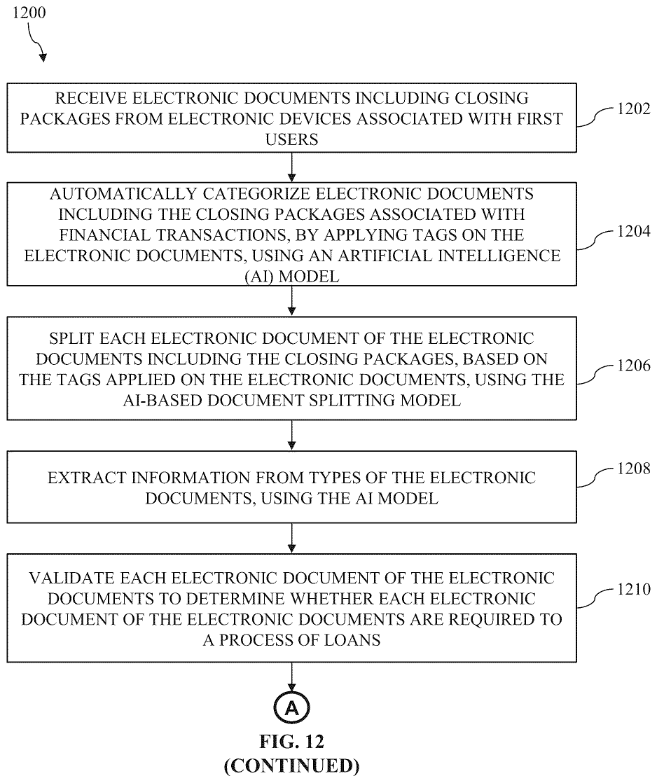

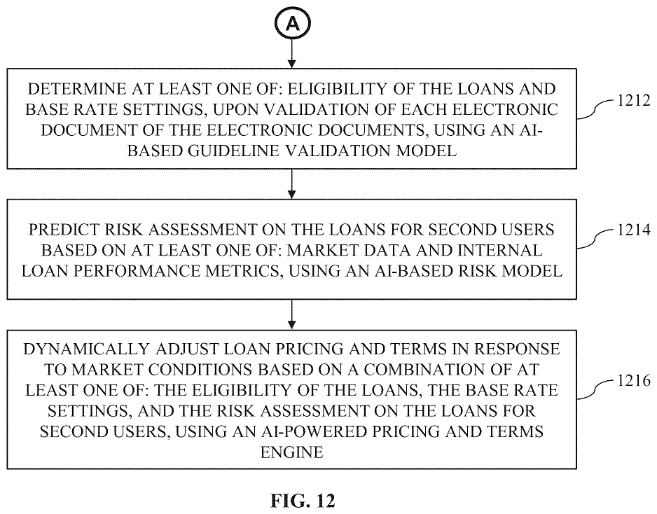

FIG. 12 is a flow chart illustrating an artificial intelligence based (AI-based) method 1200 for managing the one or more electronic documents including the closing packages and providing the dynamic risk assessment and loan pricing based on the real-time data, in accordance with an embodiment of the present disclosure.

At step 1202, the one or more electronic documents including the closing packages are received from the one or more electronic devices 102 associated with the one or more first users. In an embodiment, the closing packages may include the set of the one or more electronic documents associated with the one or more financial transactions. In an embodiment, the one or more electronic documents are corresponding to the form of the portable document format (PDF).

At step 1204, the one or more electronic documents including the closing packages associated with one or more financial transactions, are automatically categorized by applying the one or more tags on the one or more electronic documents, using the artificial intelligence (AI) model.

At step 1206, each electronic document of the one or more electronic documents including the closing packages, is split based on the one or more tags applied on the one or more electronic documents, using the AI-based document splitting model.

At step 1208, the one or more information are extracted from the one or more types of the one or more electronic documents, using the AI model.

At step 1210, each electronic document of the one or more electronic documents is validated to determine whether each electronic document of the one or more electronic documents are required to the process of one or more loans.

At step 1212, at least one of: the eligibility of the one or more loans and the base rate settings, is determined upon validation of each electronic document of the one or more electronic documents, using the AI-based guideline validation model.

At step 1214, the risk assessment on the one or more loans for one or more second users, is predicted based on at least one of: the one or more market data and the one or more internal loan performance metrics, using the AI-based risk model.

At step 1216, the loan pricing and terms in response to market conditions are dynamically adjusted based on the combination of at least one of: the eligibility of the one or more loans, the base rate settings, and the risk assessment on the one or more loans for one or more second users, using the AI-powered pricing and terms engine.

The present invention has following advantages. The present invention with the AI-based system 104 that leverages artificial intelligence to enhance document management within the loan closing process and to provide dynamic risk assessment and loan pricing based on real-time data. The present invention with the AI-based system 104 and method 1200 for automated loan underwriting and dynamic pricing engine.

The present invention with the AI-based system 104 is configured to manage the one or more electronic documents with enhanced accuracy and efficiency through AI-driven automation. The present invention with the AI-based system 104 is configured to predict the real-time risk assessment capabilities, allowing for adaptive responses to changing market and borrower (e.g., the one or more second users) data. The dynamic pricing and term adjustments ensure optimal loan conditions that reflect current market realities.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the AI-based system 104 either directly or through intervening I/O controllers. Network adapters may also be coupled to the AI-based system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/AI-based system 104 in accordance with the embodiments herein. The AI-based system 104 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the AI-based system 104. The AI-based system 104 can read the inventive instructions on the program storage devices and follow these instructions to execute the methodology of the embodiments herein.

The AI-based system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. An artificial intelligence based (AI-based) method for managing one or more electronic documents comprising closing packages, the AI-based method comprising:
receiving, by one or more hardware processors, the one or more electronic documents comprising the closing packages from one or more electronic devices associated with one or more first users, wherein the closing packages comprise a set of the one or more electronic documents associated with one or more financial transactions, wherein the one or more electronic documents are corresponding to a form of a portable document format (PDF);
automatically categorizing, by the one or more hardware processors, the one or more electronic documents comprising the closing packages associated with one or more financial transactions, by applying one or more tags on the one or more electronic documents, using an artificial intelligence (AI) model;
splitting, by the one or more hardware processors, each electronic document of the one or more electronic documents comprising the closing packages, based on the one or more tags applied on the one or more electronic documents, using an AI-based document splitting model;
extracting, by the one or more hardware processors, one or more information from one or more types of the one or more electronic documents, using the AI model;
validating, by the one or more hardware processors, each electronic document of the one or more electronic documents to determine whether each electronic document of the one or more electronic documents are required to a process of one or more loans;
determining, by the one or more hardware processors, at least one of: eligibility of the one or more loans and base rate settings, upon validation of each electronic document of the one or more electronic documents, using an AI-based guideline validation model;
predicting, by the one or more hardware processors, risk assessment on the one or more loans for one or more second users based on at least one of: one or more market data and one or more internal loan performance metrics, using an AI-based risk model; and
dynamically adjusting, by the one or more hardware processors, loan pricing and terms in response to market conditions based on a combination of at least one of: the eligibility of the one or more loans, the base rate settings, and the risk assessment on the one or more loans for one or more second users, using an AI-powered pricing and terms engine.

2. The AI-based method of claim 1, further comprising training the AI model to automatically categorize the one or more electronic documents comprising the closing packages, wherein training the AI model comprises:
obtaining, by the one or more hardware processors, one or more first training datasets associated with the one or more text formats of the one or more electronic documents corresponding to one or more predefined tags;
generating, by the one or more hardware processors, one or more feature vectors by processing the one or more first training datasets using at least one of: optical character recognition (OCR) engine and natural language processing (NLP) model;
correlating, by the one or more hardware processors, the generated one or more feature vectors with one or more respective tags being assigned for the one or more electronic documents;
training, by the one or more hardware processors, the AI model based on the correlation between the generated one or more feature vectors and the one or more respective tags, wherein the AI model comprises a Stochastic Gradient Descent (SGD) classification model; and
determining, by the one or more hardware processors, one or more tags being applied on the one or more electronic documents to automatically categorize the one or more electronic documents, based on the trained AI model.

3. The AI-based method of claim 1, wherein splitting each electronic document of the one or more electronic documents comprising the closing packages, using the AI-based document splitting model, comprises:
converting, by the one or more hardware processors, the one or more electronic documents from the portable document format (PDF) to one or more text formats using the OCR engine;
processing, by the one or more hardware processors, the converted one or more text formats of the one or more electronic documents to extract a list of page numbers for each electronic document of the one or more electronic documents, using a Spacy named entity recognition (NER) model;
converting, by the one or more hardware processors, the one or more electronic documents from the portable document format (PDF) to one or more image formats;
predicting, by the one or more hardware processors, a type of one or more pages of the one or more electronic documents based on the converted one or more image formats of the one or more electronic documents, using a convolutional neural network (CNN) model, wherein the type of one or more pages of the one or more electronic documents comprise at least one of: start page, middle page, end page, filler page, and single page, of the one or more electronic documents;
determining, by the one or more hardware processors, a boundary of each electronic document of the one or more electronic documents by combining the extracted list of page numbers for each electronic document of the one or more electronic documents and predicted type of the one or more pages of the one or more electronic documents, using the AI-based document splitting model;
tagging, by the one or more hardware processors, each electronic documents of the one or more electronic documents based on the one or more types of the one or more electronic documents, using a document tag classifier, wherein the document tag classifier comprises a Stochastic Gradient Descent (SGD) classifier; and
splitting, by the one or more hardware processors, each electronic document of the one or more electronic documents based on the one or more tags applied on the one or more electronic documents.

4. The AI-based method of claim 1, further comprising training, by the one or more hardware processors, the AI model to extract the one or more information from the one or more types of the one or more electronic documents, wherein training the AI model comprises:
obtaining, by the one or more hardware processors, a set of electronic documents comprising the one or more types of the one or more electronic documents, wherein the one or more types of the one or more electronic documents comprise at least one of: one or more notes, housing and urban development document, social security number (SSN), and driving licenses;
annotating, by the one or more hardware processors, the one or more types of the one or more electronic documents to indicate one or more key details comprising at least one of: one or more names of the one or more second users, one or more SSN values, and one or more loan values;
extracting, by the one or more hardware processors, one or more features from the annotated one or more electronic documents using the NLP model, wherein the NLP model comprises a SpaCy library model; and
training, by the one or more hardware processors, the AI model with the extracted one or more features and the annotated one or more electronic documents, to analyze the one or more information from each type of the one or more electronic documents.

5. The AI-based method of claim 1, further comprising sending, by the one or more hardware processors, one or more notifications to the one or more electronic devices associated with the one or more first users when the one or more electronic documents are at least one of: missing and incomplete, wherein the one or more notifications comprise a request of submission of the one or more electronic documents being missed during the process of the one or more loans.

6. The AI-based method of claim 1, wherein determining at least one of: eligibility of the one or more loans and the base rate settings using the AI-based guideline validation model, comprises at least one of:
determining, by the one or more hardware processors, at least one of: eligibility of the one or more loans and the base rate settings, based on one or more factors comprising at least one of: evaluations of credit score, loan-to-value ratio defining property value corresponding to a loan amount, eligibility of the one or more second users and one or more properties;
determining, by the one or more hardware processors, whether the one or more loans meet one or more minimum standards indicating an acceptation of the one or more first users on the one or more loans;
determining, by the one or more hardware processors, base pricings for the one or more loans based on one or more first fields comprising at least one of: information associated with a loan amount, experience of the one or more second users, one or more credit scores, and demography; and
determining, by the one or more hardware processors, optimized pricings for the one or more loans based on one or more second fields obtained from the one or more second users, wherein the one or more second fields comprise one or more properties belonging to the one or more second users.

7. The AI-based method of claim 1, further comprising training, by the one or more hardware processors, the AI-based risk model to predict the risk assessment on the one or more loans for the one or more second users, wherein training the AI-based risk model comprises:
obtaining, by the one or more hardware processors, one or more second training datasets comprising one or more data from one or more data sources, wherein the one or more data comprise at least one of: the one or more market data, one or more user geographical and financial data, one or more loan performance data, and one or more social media data; and
training, by the one or more hardware processors, the AI-based risk model based on the one or more second training datasets using a grid search approach, wherein the AI-based risk model comprises an extreme gradient boosting (XGBoost) model, wherein training the AI-based risk model comprises:
defining, by the one or more hardware processors, a range of values for each hyperparameter to be tuned in the AI-based risk model, wherein defining the range of values for each hyperparameter comprises assigning maximum, minimum, and step size for each hyperparameter of one or more hyperparameters, wherein the one or more hyperparameters comprise at least one of: learning rate, tree depth, and number of trees;
generating, by the one or more hardware processors, a grid search space by combining the range of values from the one or more hyperparameters;
generating, by the one or more hardware processors, an optimized grid of configurations for the AI-based risk model based on the combination of the range of values from the one or more hyperparameters; and
training, by the one or more hardware processors, the XGBoost model on the one or more second trained datasets using k-fold cross-validation to determine robustness and prevent overfitting.

8. The AI-based method of claim 7, further comprising evaluating, by the one or more hardware processors, performance of the trained AI-based risk model using one or more metrics comprising root mean squared error (RMSE), wherein the RMSE indicates close matching of the prediction of the AI-based risk model with one or more actual values.

9. The AI-based method of claim 8, further comprising adjusting, by the one or more hardware processors, the one or more hyperparameters to fine-tune the AI-based risk model with minimum RMSE for dynamically predicting the risk assessment with optimized accuracy.

10. An artificial intelligence based (AI-based) system for managing one or more electronic documents comprising closing packages, the AI-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a document receiving subsystem configured to receive the one or more electronic documents comprising the closing packages from one or more electronic devices associated with one or more first users, wherein the closing packages comprise a set of the one or more electronic documents associated with one or more financial transactions, wherein the one or more electronic documents are corresponding to a form of a portable document format (PDF);
a document categorizing subsystem configured to automatically categorize the one or more electronic documents comprising the closing packages associated with one or more financial transactions, by applying one or more tags on the one or more electronic documents, using an artificial intelligence (AI) model;
a document splitting subsystem configured to split each electronic document of the one or more electronic documents comprising the closing packages, based on the one or more tags applied on the one or more electronic documents, using an AI-based document splitting model;
an information extraction subsystem configured to extract one or more information from one or more types of the one or more electronic documents, using the AI model;
a document validation subsystem configured to validate each electronic document of the one or more electronic documents to determine whether each electronic document of the one or more electronic documents are required to a process of one or more loans;
a loan eligibility determining subsystem configured to determine at least one of:
eligibility of the one or more loans and base rate settings, upon validation of each electronic document of the one or more electronic documents, using an AI-based guideline validation model;
a risk assessment prediction subsystem configured to predict risk assessment on the one or more loans for one or more second users based on at least one of: one or more market data and one or more internal loan performance metrics, using an AI-based risk model; and
a loan price adjusting subsystem configured to dynamically adjust loan pricing and terms in response to market conditions based on a combination of at least one of: the eligibility of the one or more loans, the base rate settings, and the risk assessment on the one or more loans for one or more second users, using an AI-powered pricing and terms engine.

11. The AI-based system of claim 10, further comprising a training system configured to train the AI model for automatically categorizing the one or more electronic documents comprising the closing packages, wherein in training the AI model, the training subsystem is configured to:
obtain one or more first training datasets associated with one or more text formats of the one or more electronic documents corresponding to one or more predefined tags;
generate one or more feature vectors by processing the one or more first training datasets using at least one of: optical character recognition (OCR) engine and natural language processing (NLP) model;
correlate the generated one or more feature vectors with one or more respective tags being assigned for the one or more electronic documents;
train the AI model based on the correlation between the generated one or more feature vectors and the one or more respective tags, wherein the AI model comprises a Stochastic Gradient Descent (SGD) classification model; and
determine one or more tags being applied on the one or more electronic documents to automatically categorize the one or more electronic documents, based on the trained AI model.

12. The AI-based system of claim 10, wherein in splitting each electronic document of the one or more electronic documents comprising the closing packages, using the AI-based document splitting model, the document splitting subsystem is further configured to:
convert the one or more electronic documents from the portable document format (PDF) to the one or more text formats using the OCR engine;
process the converted one or more text formats of the one or more electronic documents to extract a list of page numbers for each electronic document of the one or more electronic documents, using a Spacy named entity recognition (NER) model;
convert the one or more electronic documents from the portable document format (PDF) to one or more image formats;
predict a type of one or more pages of the one or more electronic documents based on the converted one or more image formats of the one or more electronic documents, using a convolutional neural network (CNN) model, wherein the type of one or more pages of the one or more electronic documents comprise at least one of: start page, middle page, end page, filler page, and single page, of the one or more electronic documents;
determine a boundary of each electronic document of the one or more electronic documents by combining the extracted list of page numbers for each electronic document of the one or more electronic documents and predicted type of the one or more pages of the one or more electronic documents, using the AI-based document splitting model; and
tag each electronic documents of the one or more electronic documents based on the one or more types of the one or more electronic documents, using a document tag classifier, wherein the document tag classifier comprises a Stochastic Gradient Descent (SGD) classifier; and
split each electronic document of the one or more electronic documents based on the one or more tags applied on the one or more electronic documents.

13. The AI-based system of claim 10, wherein the training subsystem is configured to train the AI model for extracting the one or more information from the one or more types of the one or more electronic documents, wherein in training the AI model, the training subsystem is configured to:
obtain a set of electronic documents comprising the one or more types of the one or more electronic documents, wherein the one or more types of the one or more electronic documents comprise at least one of: one or more notes, housing and urban development document, social security number (SSN), and driving licenses;
annotate the one or more types of the one or more electronic documents to indicate one or more key details comprising at least one of: one or more names of the one or more second users, one or more SSN values, and one or more loan values;
extract one or more features from the annotated one or more electronic documents using the NLP model, wherein the NLP model comprises a SpaCy library model; and
train the AI model with the extracted one or more features and the annotated one or more electronic documents, to analyze the one or more information from each type of the one or more electronic documents.

14. The AI-based system of claim 10, wherein the document validation subsystem is further configured to send one or more notifications to the one or more electronic devices associated with the one or more first users when the one or more electronic documents are at least one of: missing and incomplete, wherein the one or more notifications comprise a request of submission of the one or more electronic documents being missed during the process of the one or more loans.

15. The AI-based system of claim 10, wherein in determining at least one of: eligibility of the one or more loans and the base rate settings using the AI-based guideline validation model, the loan eligibility determining subsystem is configured to:
determine at least one of: eligibility of the one or more loans and the base rate settings, based on one or more factors comprising at least one of: evaluations of credit score, loan-to-value ratio defining property value corresponding to a loan amount, eligibility of the one or more second users and one or more properties;
determine whether the one or more loans meet one or more minimum standards indicating an acceptation of the one or more first users on the one or more loans;
determine base pricings for the one or more loans based on one or more first fields comprising at least one of: information associated with a loan amount, experience of the one or more second users, one or more credit scores, and demography; and
determine optimized pricings for the one or more loans based on one or more second fields obtained from the one or more second users, wherein the one or more second fields comprise one or more properties belonging to the one or more second users.

16. The AI-based system of claim 10, wherein the training subsystem is configured to train the AI-based risk model for predicting the risk assessment on the one or more loans for the one or more second users, wherein in training the AI-based risk model, the training subsystem is configured to:
obtain one or more second training datasets comprising one or more data from one or more data sources, wherein the one or more data comprise at least one of: the one or more market data, one or more user geographical and financial data, one or more loan performance data, and one or more social media data; and
train the AI-based risk model based on the one or more second training datasets using a grid search approach, wherein the AI-based risk model comprises an extreme gradient boosting (XGBoost) model, wherein training the AI-based risk model comprises:
defining a range of values for each hyperparameter to be tuned in the AI-based risk model, wherein defining the range of values for each hyperparameter comprises assigning maximum, minimum, and step size for each hyperparameter of one or more hyperparameters, wherein the one or more hyperparameters comprise at least one of: learning rate, tree depth, and number of trees;
generating a grid search space by combining the range of values from the one or more hyperparameters;
generating an optimized grid of configurations for the AI-based risk model based on the combination of the range of values from the one or more hyperparameters; and
training the XGBoost model on the one or more second trained datasets using k-fold cross-validation to determine robustness and prevent overfitting.

17. The AI-based system of claim 16, wherein the training subsystem is further configured to evaluate performance of the trained AI-based risk model using one or more metrics comprising root mean squared error (RMSE), wherein the RMSE indicates close matching of the prediction of the AI-based risk model with one or more actual values.

18. The AI-based system of claim 17, wherein the training subsystem is further configured to adjust the one or more hyperparameters to fine-tune the AI-based risk model with minimum RMSE for dynamically predicting the risk assessment with optimized accuracy.

19. A non-transitory computer-readable storage medium having instructions stored therein that when executed by a hardware processor, cause the processor to execute operations of:
receiving the one or more electronic documents comprising closing packages from one or more electronic devices associated with one or more first users, wherein the closing packages comprise a set of the one or more electronic documents associated with one or more financial transactions, wherein the one or more electronic documents are corresponding to a form of a portable document format (PDF);
automatically categorizing the one or more electronic documents comprising the closing packages associated with one or more financial transactions, by applying one or more tags on the one or more electronic documents, using an artificial intelligence (AI) model;
splitting each electronic document of the one or more electronic documents comprising the closing packages, based on the one or more tags applied on the one or more electronic documents, using the AI-based document splitting model;
extracting one or more information from one or more types of the one or more electronic documents, using the AI model;
validating each electronic document of the one or more electronic documents to determine whether each electronic document of the one or more electronic documents are required to a process of one or more loans;
determining at least one of: eligibility of the one or more loans and base rate settings, upon validation of each electronic document of the one or more electronic documents, using an AI-based guideline validation model;
predicting risk assessment on the one or more loans for one or more second users based on at least one of: one or more market data and one or more internal loan performance metrics, using an AI-based risk model; and
dynamically adjusting loan pricing and terms in response to market conditions based on a combination of at least one of: the eligibility of the one or more loans, the base rate settings, and the risk assessment on the one or more loans for one or more second users, using an AI-powered pricing and terms engine.

20. The non-transitory computer-readable storage medium of claim 19, wherein splitting each electronic document of the one or more electronic documents comprising the closing packages, using the AI-based document splitting model, comprises:
converting the one or more electronic documents from the portable document format (PDF) to one or more text formats using the OCR engine;
processing the converted one or more text formats of the one or more electronic documents to extract a list of page numbers for each electronic document of the one or more electronic documents, using a Spacy named entity recognition (NER) model;
converting the one or more electronic documents from the portable document format (PDF) to one or more image formats;
predicting a type of one or more pages of the one or more electronic documents based on the converted one or more image formats of the one or more electronic documents, using a convolutional neural network (CNN) model, wherein the type of one or more pages of the one or more electronic documents comprise at least one of: start page, middle page, end page, filler page, and single page, of the one or more electronic documents;
determining a boundary of each electronic document of the one or more electronic documents by combining the extracted list of page numbers for each electronic document of the one or more electronic documents and predicted type of the one or more pages of the one or more electronic documents, using AI-based document splitting model; and
tagging each electronic documents of the one or more electronic documents based on the one or more types of the one or more electronic documents, using a document tag classifier, wherein the document tag classifier comprises a Stochastic Gradient Descent (SGD) classifier; and splitting each electronic document of the one or more electronic documents based on the one or more tags applied on the one or more electronic documents.
